(19) United States
(12) Patent Application Publication
(10) Pub. No.: US 2024/0009645 A1
(43) Pub. Date: Jan. 11, 2024

(54) PEGBOARD PROTEIN PURIFICATION PLATE FOR HIGH THROUGHPUT PROTEIN CHARACTERIZATION

(71) Applicant: Alliance for Sustainable Energy, LLC, Golden, CO (US)

(72) Inventors: Sylvia SARNIK, Lakewood, CO (US); Simon James Bradshaw MALLINSON, Lakewood, CO (US); Peter SMITH, Arvada, CO (US); Yannick J. BOMBLE, Arvada, CO (US); Hunter Blake HARRINGTON, Lakewood, CO (US)

(21) Appl. No.: 18/349,867

(22) Filed: Jul. 10, 2023

Related U.S. Application Data
(60) Provisional application No. 63/359,649, filed on Jul. 8, 2022.

(51) Int. Cl. B01J 19/00

(52) U.S. Cl. CPC B01J 19/0046; B01J 2219/00623; B01J 2219/00668; B01J 2219/00725

(57) ABSTRACT

Disclosed herein are methods and compositions for a new way to separate biologics using coated pegboards—plastic plates affixed with an array of 96-pegs which align with the wells of a traditional 96-well plate used in bench top experiments. The ends of the pegs are conjugated to various compounds which are able to bind tags on engineered proteins (ex. Ni-NTA would bind a His-Tag on an engineered protein). These pegs extend into plate wells to specifically bind the tagged protein from the cell lysate which contains hundreds of other proteins. The pegboard, now laden with the protein of interest (POI), may then be dipped into sequential buffers to wash away potential non-specifically bound proteins to purify the POI.

### CROSS-REFERENCE TO RELATED APPLICATION

This application claims the benefit of U.S. Patent Application No. 63/359,649 filed on 8 Jul. 2022 which is incorporated by reference herein its entirety.

### CONTRACTUAL ORIGIN

The United States Government has rights in this invention under Contract No. DE-AC36-08GO28308 between the United States Department of Energy and Alliance for Sustainable Energy, LLC, the Manager and Operator of the National Renewable Energy Laboratory.

### BACKGROUND

Existing techniques exist to purify biologics from the cellular milieu. One technique is to use magnetic beads with DNA-affinity in the sample, then insert a magnetic probe into the well to collect the beads, immerse in wash solutions then elute DNA off of beads. This technology involves a plate with 96-pegs (magnetic) which serve to collect magnetic particles that have bound the protein of interest. Other existing techniques for purification of biologics uses magnetic beads and particles but is tube-based and requires an external magnetic rack, individual handling of tubes and pipetting fluids in/out for repeated washes which leads to loss when magnetic beads are accidentally removed. Another technique uses a liquid resin such as agarose beads and columns and can be used for medium-throughput applications. This technique requires a lot of centrifugations and again introduce pipetting errors. Columns are used for ultra-high purification of proteins and also are able to purify higher quantities of protein, though usually require expensive machinery (HPLC/FPLC) and suffer low throughput. These methods are harder to automate as well.

Plate based methods (coated plates, or 96-well plate inserts) are typically used for DNA/RNA purifications, however, they can also be applied to protein purification for higher throughput applications. This method is error prone with pipetting in/out leading to loss, especially in high throughput. Additionally moving liquid in/out of 96-wells is time intensive and uses a lot of plastic when swapping out tips between samples.

### SUMMARY

In an aspect, disclosed herein are systems, compositions of matter and methods for using plastic plates affixed with an array of 96-pegs which align with the wells of a traditional 96-well plate used in bench top experiments. The ends of the pegs are conjugated to various compounds which are able to bind tags on engineered proteins (ex. Ni-NTA would bind a His-Tag on an engineered protein). In additional embodiments, the ends of the pegs are conjugated to various compounds which are able to bind tags on engineered biological moieties comprising RNA molecules, DNA molecules and proteins of interest. These pegs extend into the bottom of the plate wells to specifically bind the tagged protein from the cell lysate which contains hundreds of other proteins. The pegboard, now laden with the protein of interest (POI), may then be dipped into sequential buffers to wash away potential non-specifically bound proteins to purify the POI. Finally, the pegboard can be dipped into a plate containing reaction buffer where the POI activity can be directly measured, or otherwise may be eluted off of the peg to generate stocks of purified protein.

In an aspect, disclosed herein is a system for using plates affixed with an array of pegs which interact with the wells of a well plate; wherein the pegs are conjugated to compounds which bind tags on an engineered biological moiety; and wherein the pegs extend into the well plate to bind the tags on the engineered biological moiety. In an embodiment, the engineered biological moiety is part of a cell lysate. In an embodiment, the engineered biological moiety is a DNA molecule. In an embodiment, the engineered biological moiety is a RNA molecule. In an embodiment, the engineered biological moiety is a protein. In an embodiment, the tags on the engineered biological moiety comprise FLAG, HPC, GST, His-Tag, Strep II, and avidin-biotin system tags. In an embodiment, the tags on the engineered DNA molecule comprise FLAG, HPC, GST, His-Tag, Strep II, and avidin-biotin system tags. In an embodiment, the engineered RNA molecule comprise FLAG, HPC, GST, His-Tag, Strep II, and avidin-biotin system tags. In an embodiment, the tags on the engineered protein comprise FLAG, HPC, GST, His-Tag, Strep II, and avidin-biotin system tags.

In an aspect, disclosed herein is a method for purifying an engineered biological moiety using plates affixed with an array of pegs which interact with the wells of a well plate; wherein the pegs are conjugated to compounds which bind tags on an engineered biological moiety; and wherein the pegs extend into the well plate to bind the tags on the engineered biological moiety; and wherein the method comprises the step of incubating the pegs in a cell-extract solution within the well plate; and wherein the cell-extract solution comprises an engineered biological moiety. In an embodiment, the engineered biological moiety is part of a cell lysate. In an embodiment, the engineered biological moiety is a DNA molecule. In an embodiment, the engineered biological moiety is a RNA molecule. In an embodiment, the engineered biological moiety is a protein. In an embodiment, the tags on the engineered biological moiety comprise FLAG, HPC, GST, His-Tag, Strep II, and avidin-biotin system tags. In an embodiment, the engineered DNA molecule comprise FLAG, HPC, GST, His-Tag, Strep II, and avidin-biotin system tags. In an embodiment, the engineered RNA molecule comprise FLAG, HPC, GST, His-Tag, Strep II, and avidin-biotin system tags. In an embodiment, the tags on the engineered protein comprise FLAG, HPC, GST, His-Tag, Strep II, and avidin-biotin system tags. In an embodiment, the method further comprises washing the incubated pegs to remove non-specific binding of non-engineered biological moieties. In an embodiment, the method further comprises eluting the bound biological moieties from the pegs.

Other objects, advantages, and novel features of the present invention will become apparent from the following detailed description of the invention when considered in conjunction with the accompanying drawings.

### BRIEF DESCRIPTION OF THE DRAWINGS

FIG. 1 depicts a system of using a purification pegboard for high throughput purification of enzymes. The system essentially acts like a “stamp”, has dimensions of 96-well (universally compatible with current labware), exhibits one peg per well, and is surface coated with a compound to bind proteins. Various peg geometries are contemplated which fit flat, or PCR 96-well plates which can also tune binding capacity (i.e., peg surface area).

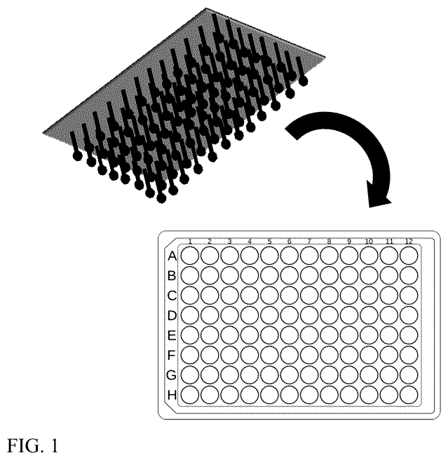

FIG. 2 depicts a flow chart of an embodiment of a method disclosed herein which is useful for the high throughput purification of proteins using compositions and systems disclosed herein. In an embodiment, 96 samples of purified protein are produced in less than about 20 min which is easy to perform in parallel and exhibits decreased error and is capable of purifying low volumes.

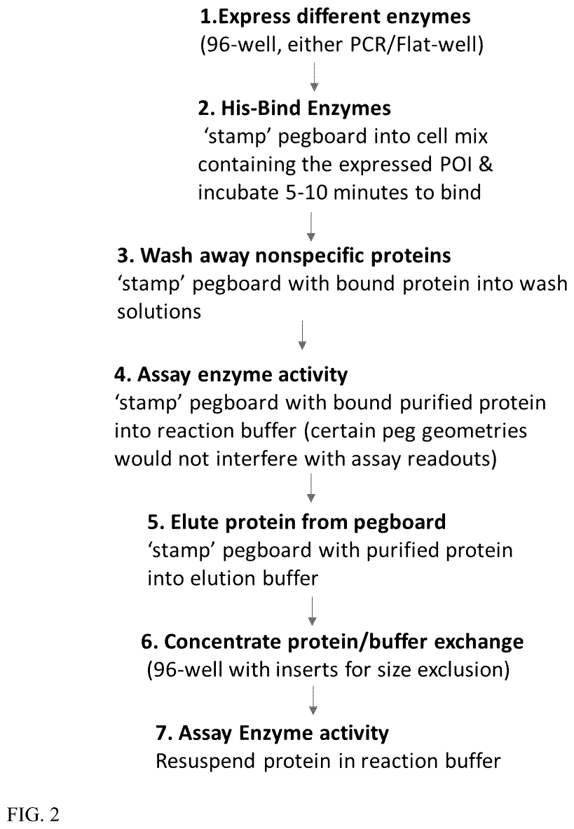

FIGS. 3A, and 3B depict plate geometries contemplated in embodiments disclosed herein.

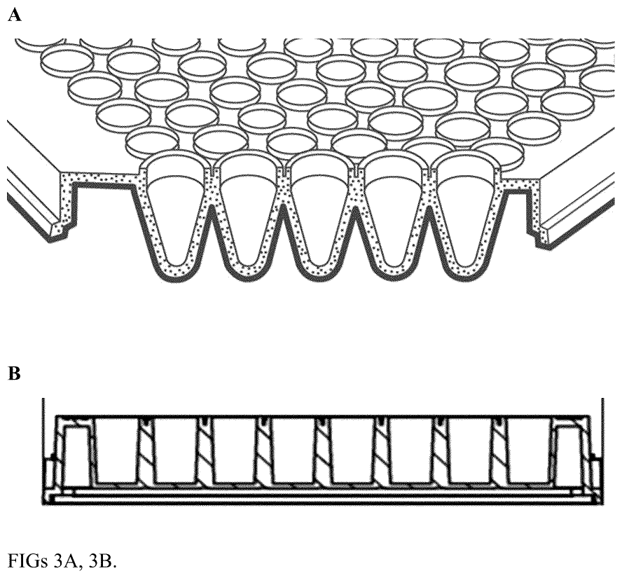

FIGS. 4A, 4B, 4C, 4D and 4E depict contemplated peg designs to suit corresponding plate geometries. FIG. 4A depicts a rounded-cone peg which pushes fluid up around edges to increase surface/binding area. FIG. 4B depicts a hollow cylinder peg with high surface area for binding plate-readers and can be used with peg still in the plate, for example. FIG. 4C depicts a solid cylinder peg which maximizes contact area with small sample volumes and exhibits an easily tunable surface area to tailor binding capacity. FIG. 4D depicts a cone shape with no-base peg which maximizes contact area with small sample volumes and exhibits an easily tunable surface area to tailor binding capacity. FIG. 4E depicts a cone shape with beveled edges peg which maximizes contact area with small sample volumes and exhibits an easily tunable surface area to tailor binding capacity.

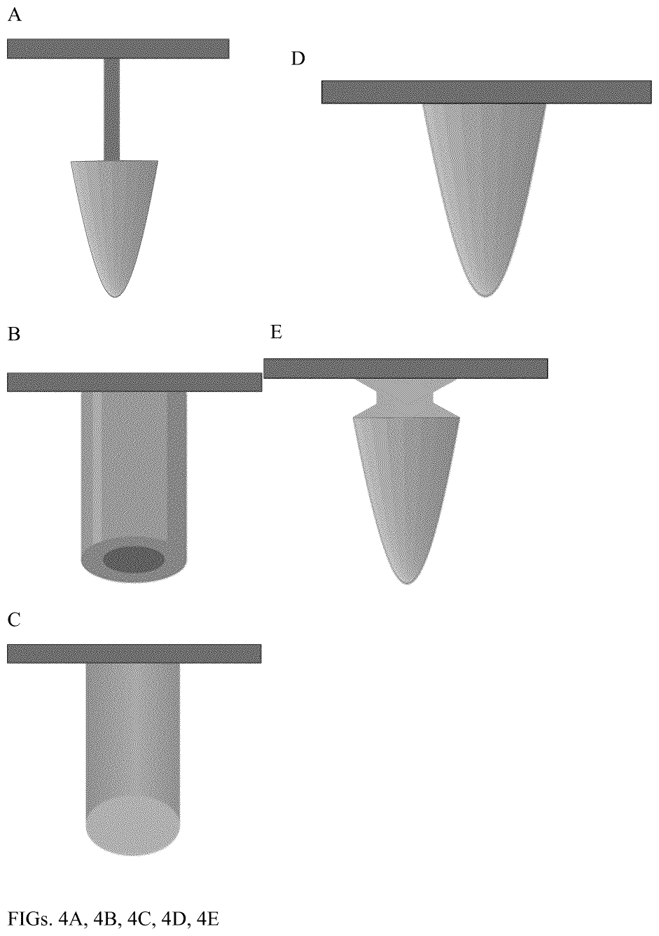

FIGS. 5A, 5B depict (FIG. 5A) AFU over time, BDH bound to Pegboard; and (FIG. 5B) A420 over time POD bound to Pegboard. As depicted in FIGS. 5A and 5B, the Pegboard binds protein and allows facile activity assays in high throughput for non-functionalized (bare plastic)—BDH which binds protein from buffer; allows for functionalized (FSL-biotin coated plastic)—POD which binds protein from buffer; concentration dependent activity; and works for different proteins and reactions.

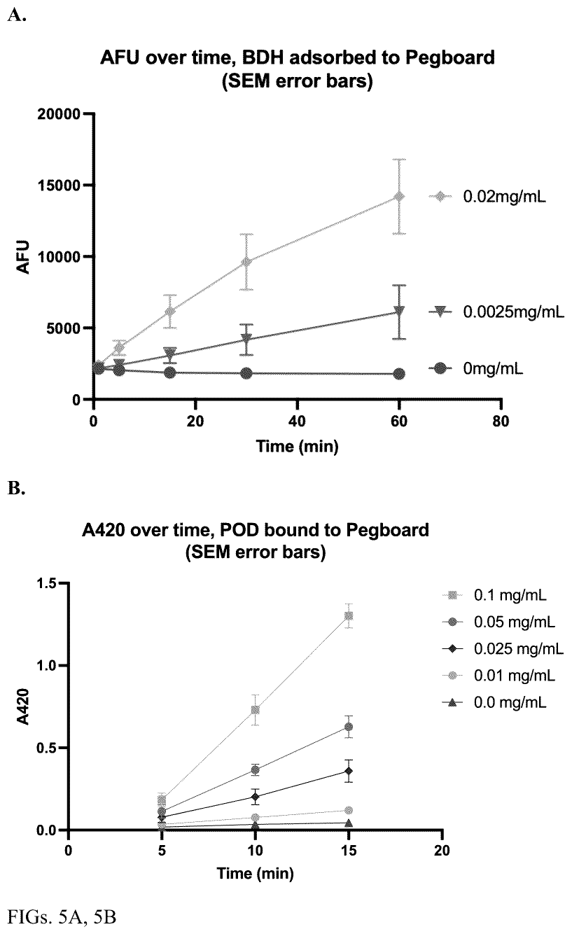

### DETAILED DESCRIPTION

In an embodiment, disclosed herein are methods and compositions of matter comprising DNA, RNA and protein purification. In an embodiment, the methods disclosed herein represent a new way to separate biologics using coated pegboards on plastic plates affixed with an array of 96-pegs which align with the wells of a traditional 96-well plate used in bench top experiments. The ends of the pegs are conjugated to various compounds which are able to bind tags on engineered proteins (ex. Ni-NTA would bind a His-Tag on an engineered protein). In additional embodiments, the ends of the pegs are conjugated to various compounds which are able to bind tags on engineered biological moieties comprising RNA molecules, DNA molecules and proteins of interest. These pegs extend into the bottom of the plate wells to specifically bind the tagged protein from the cell lysate which contains hundreds of other proteins. The pegboard, now laden with the protein of interest (POI), may then be dipped into sequential buffers to wash away potential non-specifically bound proteins to purify the POI. Finally, the pegboard can be dipped into a plate containing reaction buffer where the POI activity can be directly measured, or otherwise may be eluted off of the peg to generate stocks of purified protein.

Benefits over existing techniques include less plastic waste by using fewer pipette tips and reusing the binding plates; saving time by handling 96 samples at a time resulting in a less than 20 minute purification system that exhibits the potential for facile integration into a robotics platform; tunable binding capacity that can be used to normalize protein levels for assays; and can be expanded to use with a broad range of affinity tags including, but not limited to, FLAG, HPC, GST, His-Tag, Strep II, and avidin-biotin systems.

In an embodiment, the system and device of coated pegboards can be made of a variety of materials or methods to tailor surface area to the application. 3D printing leaves a porous surface texture vs smooth from injection molding.

In an embodiment, a bound protein on the pegboard can be reused for multiple rounds of assay (dictated by the lifetime of the enzyme).

In an embodiment, uncoated plastic may be used to make the Pegboard. This could allow for an activity assay of adsorbed or bound protein that has been pre-purified. An additional benefit is that this embodiment could be useful for testing different reaction conditions.

In an embodiment, this system and device of coated pegboards affixed to plates is able to assist in high-throughput protein purification. With the pegboard, 96-enzyme mutants can be manipulated at once, and purification time is much quicker compared to traditional protein-purification methods, making the whole process of testing enzyme mutants much more rapid. In an embodiment, the system can be used to tailor the binding capacity of each peg for a POI allowing for tighter control of experimental conditions, and normalizing protein levels when assaying activity.

In an embodiment, the devices disclosed herein are able to assist in high-throughput protein purification. With the pegboard, 96-enzyme mutants can be manipulated at once, and purification time is much quicker compared to traditional protein-purification methods, making the whole process of testing enzyme mutants much more rapid. In an embodiment, this invention is uniquely able to tailor the binding capacity of each peg for the POI, allowing for tighter control of experimental conditions, and normalizing protein levels when assaying activity.

In an embodiment, the methods, systems and compositions of matter disclosed herein require only the plastic plate coated in a binding-compound for the POI. In an embodiment, the methods, systems and compositions of matter disclosed herein would be able to be automated for robotics platforms. In an embodiment, the plate is reused with thorough washing, and re-charging of the bind chemical to reduce plastic waste.

Disclosed herein are novel plate designs and geometries of pegs useful for high throughput purification of biologics such as proteins.

The foregoing disclosure has been set forth merely to illustrate the invention and is not intended to be limiting.

We claim:

1. A system for using plates affixed with an array of pegs which interact with the wells of a well plate; wherein the pegs are conjugated to compounds which bind tags on an engineered biological moiety; and wherein the pegs extend into the well plate to bind the tags on the engineered biological moiety.

2. The system of claim 1 wherein the engineered biological moiety is part of a cell lysate.

3. The system of claim 1 wherein the engineered biological moiety is a DNA molecule.

4. The system of claim 1 wherein the engineered biological moiety is a RNA molecule.

5. The system of claim 1 wherein the engineered biological moiety is a protein.

6. The system of claim 1 wherein the tags on the engineered biological moiety comprise FLAG, HPC, GST, His-Tag, Strep II, and avidin-biotin system tags.

7. The system of claim 3 wherein the tags on the engineered DNA molecule comprise FLAG, HPC, GST, His-Tag, Strep II, and avidin-biotin system tags.

8. The system of claim 4 wherein the tags on the engineered RNA molecule comprise FLAG, HPC, GST, His-Tag, Strep II, and avidin-biotin system tags.

9. The system of claim 5 wherein the tags on the engineered protein comprise FLAG, HPC, GST, His-Tag, Strep II, and avidin-biotin system tags.

10. A method for purifying an engineered biological moiety using plates affixed with an array of pegs which interact with the wells of a well plate; wherein the pegs are conjugated to compounds which bind tags on an engineered biological moiety; and wherein the pegs extend into the well plate to bind the tags on the engineered biological moiety; and wherein the method comprises the step of incubating the pegs in a cell-extract solution within the well plate; and wherein the cell-extract solution comprises an engineered biological moiety.

11. The method of claim 10 wherein the engineered biological moiety is part of a cell lysate.

12. The method of claim 10 wherein the engineered biological moiety is a DNA molecule.

13. The method of claim 10 wherein the engineered biological moiety is a RNA molecule.

14. The method of claim 10 wherein the engineered biological moiety is a protein.

15. The method of claim 10 wherein the tags on the engineered biological moiety comprise FLAG, HPC, GST, His-Tag, Strep II, and avidin-biotin system tags.

16. The system of claim 12 wherein the tags on the engineered DNA molecule comprise FLAG, HPC, GST, His-Tag, Strep II, and avidin-biotin system tags.

17. The system of claim 13 wherein the tags on the engineered RNA molecule comprise FLAG, HPC, GST, His-Tag, Strep II, and avidin-biotin system tags.

18. The system of claim 14 wherein the tags on the engineered protein comprise FLAG, HPC, GST, His-Tag, Strep II, and avidin-biotin system tags.

19. The method of claim 10 further comprising washing the incubated pegs to remove non-specific binding of non-engineered biological moieties.

20. The method of claim 10 further comprising eluting the bound biological moieties from the pegs.
